(19) United States
(12) Patent Application Publication
(10) Pub. No.: US 2022/0289513 A1
(43) Pub. Date: Sep. 15, 2022

(54) SPEED ADJUSTING CABLE ASSEMBLY FOR USE WITH A CABLE FEEDER

(71) Applicant: GREENLEE TOOLS, INC., Rockford, IL (US)

(72) Inventors: Henry Alexander Fiorentini, Rockford, IL (US); Noah Eben Mehlhausen, Rockford, IL (US); Daniel John Marben, Rockford, IL (US)

(21) Appl. No.: 17/635,065

(22) PCT Filed: Aug. 14, 2020
(86) PCT No.: PCT/US2020/046315

§ 371 Date: Feb. 14, 2022

Related U.S. Application Data
(60) Provisional application No. 62/887,105, filed on Aug. 15, 2019.

(51) Int. Cl. B65H 59/38; H02G 1/06; B65H 57/18; B65H 49/34; B65H 49/20

(52) U.S. Cl. CPC B65H 59/387; H02G 1/06; B65H 57/18; B65H 49/34; B65H 49/205; B65H 2701/34; B65H 2513/11

(57) ABSTRACT

A speed adjusting cable assembly in accordance with some example embodiments is configured for use with a cable feeder having at least one motor-driven roller configured to pay out cable. The assembly includes a frame, a boom arm pivotally connected thereto by a shaft, a cable guide on the boom arm configured to allow at least one cable to pass therethrough, a sensor in communication with the shaft and configured to measure a rotational position of the boom arm relative to a plane, and a controller in communication with the sensor. The controller is configured to control a speed at which the at least one roller rotates to feed the cable through the cable feeder based upon information received from the sensor. A method of use is also provided.

### RELATED APPLICATION

This application claims the domestic priority of U.S. Provisional Patent Application Ser. No. 62/887,105 filed on Aug. 15, 2019, the contents of which are incorporated herein in its entirety.

### FIELD OF THE DISCLOSURE

The present disclosure generally relates to a speed adjusting cable assembly for use with a cable feeder.

### BACKGROUND

When cables, such as electrical, coaxial, telephone cables, etc. are first installed in a building, the cables are typically run through a conduit which has been previously installed in the walls of the building. The process for running a cable through the conduit typically starts with a worker shooting or blowing a “mouse” (a form of a foam plug) through the conduit where the mouse is connected to the end of a strong, lightweight nylon cord. Blowing of the mouse is achieved by placing the mouse in the conduit and applying air pressure behind the mouse to force it through the conduit. The mouse has a diameter which is slightly less than the diameter of the conduit. Therefore, the air pressure which is applied behind the mouse causes the mouse to move through the conduit, pulling the lightweight nylon cord with it.

After the mouse has been blown through the conduit such that the mouse appears at the other end of the conduit, a pulling rope, such as a heavier synthetic rope or steel cable, is connected to the end of the nylon cord, and the nylon cord is pulled back through the conduit so that the pulling rope is pulled through the conduit. Once the nylon cord has been pulled completely back through the conduit and the end of the pulling rope appears at the end of the conduit, a grouping of cable, where each cable is carried on an individual spool, reel or the like, is connected to the end of the pulling rope. Then, the pulling rope is pulled completely through the conduit as the cable unwind from their respective spools, reels or the like, and the cable advance in the conduit. Once the cable appears at the end of the conduit, the cable is disconnected from the pulling rope, and the installation of the cable in the conduit is complete.

Prior art cable feeders are available and are designed for use in pulling cable off spools, reels or the like and feeding the cable to a conduit. An example of such a cable feeder is provided in U.S. Pat. No. 6,073,916 which provides a cable feeder for removing a plurality of cable from a plurality of spools, reels or the like and thereafter feeding or advancing the cable to a conduit.

### SUMMARY

A speed adjusting cable assembly in accordance with example embodiments which is configured for use with a cable feeder having at least one motor-driven roller configured to pay out cable, includes a frame; a boom arm pivotally connected to the frame by a shaft, the boom arm having a cable guide thereon which is configured to allow at least one cable to pass therethrough; a sensor in communication with the shaft and configured to measure a rotational position of the boom arm relative to a plane; and a controller in communication with the sensor, the controller configured to control a speed at which the at least one motor-driven roller rotates to feed the cable through the cable feeder based upon information received from the sensor.

An assembly in accordance with example embodiments includes a cable feeder comprising a frame, at least one motor-driven roller mounted on the frame and configured to pay out cable; and a speed adjusting cable assembly including a frame connected to the frame of the cable feeder, a boom arm pivotally connected to the frame of the speed adjusting cable assembly by a shaft, the boom arm having a housing which is configured to sit on a top surface of the cable, and a roller attached to the housing, a sensor in communication with the shaft and configured to measure a rotational position of the boom arm relative to a plane, and a controller in communication with the sensor, the controller configured to control a speed at which the at least one motor-driven roller rotates to feed the cable through the cable feeder based upon information received from the sensor.

A method of paying out cable in accordance with example embodiments includes feeding a cable between rollers of a cable feeder, wherein at least one of the rollers is driven by a motor; feeding a cable through a cable guide of a speed adjusting cable assembly with a housing of the speed adjusting cable assembly sitting on a top surface of the cable; sensing a rotational position of the cable guide relative to a plane; and changing a speed at which the roller rotates.

This Summary is provided merely for purposes of summarizing some example embodiments so as to provide a basic understanding of some aspects of the disclosure. Accordingly, it will be appreciated that the above described example embodiments are merely examples and should not be construed to narrow the scope or spirit of the disclosure in any way. Other embodiments, aspects, and advantages of various disclosed embodiments will become apparent from the following detailed description taken in conjunction with the accompanying drawings which illustrate, by way of example, the principles of the described embodiments.

### BRIEF DESCRIPTION OF THE DRAWINGS

The organization and manner of the structure and operation of the disclosed embodiments, together with further objects and advantages thereof, may best be understood by reference to the following description, taken in connection with the accompanying drawings, which are not necessarily drawn to scale, wherein like reference numerals identify like elements in which:

FIG. 1 depicts a perspective view of an assembly including speed adjusting cable assembly and a cable feeder;

FIG. 2 depicts a side elevation views of the assembly;

FIG. 3 depicts a block diagram of a controller for use with the speed adjusting cable assembly;

FIGS. 4 and 5 depict perspective views of a boom arm and cable guide of the speed adjusting cable assembly;

FIG. 6 depicts an elevational view of the boom arm and cable guide of the speed adjusting cable assembly and in a closed and locked position;

FIG. 7 depicts an elevational view of the boom arm and cable guide of the speed adjusting cable assembly and in an unlocked and open position;

FIGS. 8 and 9 depict perspective views of alternate cable guides attached to the boom arm of the speed adjusting cable assembly;

FIG. 10 depicts a side elevational view of the assembly and showing ranges of motion for different conditions;

FIGS. 11-13 depict schematic views of the assembly and different operating conditions;

FIG. 14 depicts a side elevational view of the assembly in a storage position;

FIG. 15 depicts a perspective view of the assembly, a reel, a conduit, a cable puller, and cable being routed therethrough;

FIG. 16 depicts a perspective view of the assembly, a plurality of reel, a conduit, and a plurality of cables being routed therethrough; and

FIG. 17 depicts a side elevation of motor-driven rollers of the cable feeder, and showing a controller and a sensor in schematic form.

### DESCRIPTION

While the disclosure may be susceptible to embodiment in different forms, there is shown in the drawings, and herein will be described in detail, specific embodiments with the understanding that the present disclosure is to be considered an exemplification of the principles of the disclosure, and is not intended to limit the disclosure to that as illustrated and described herein. Therefore, unless otherwise noted, features disclosed herein may be combined together to form additional combinations that were not otherwise shown for purposes of brevity. It will be further appreciated that in some embodiments, one or more elements illustrated by way of example in a drawing(s) may be eliminated and/or substituted with alternative elements within the scope of the disclosure.

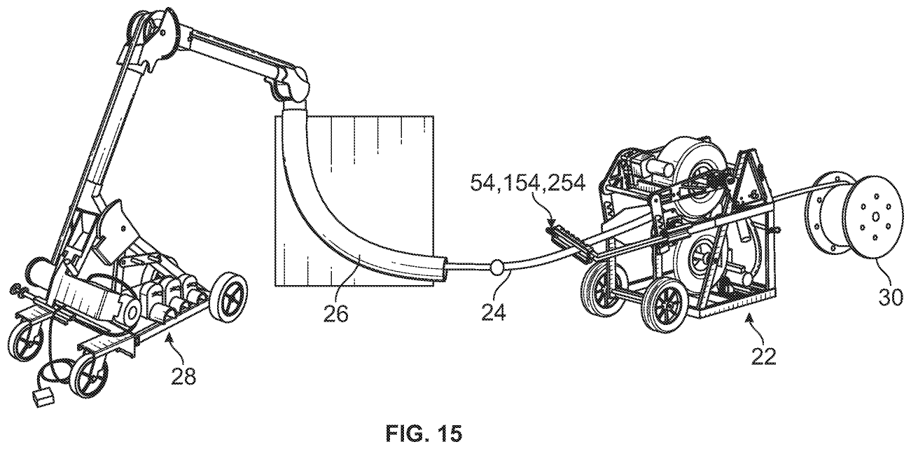

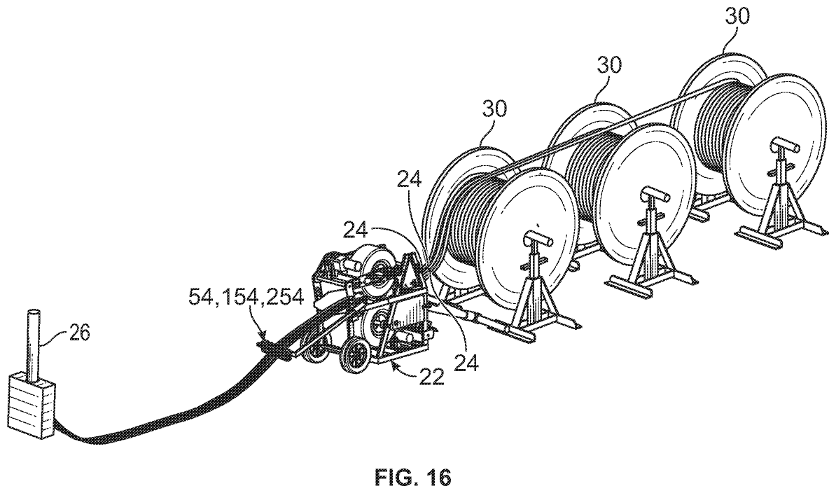

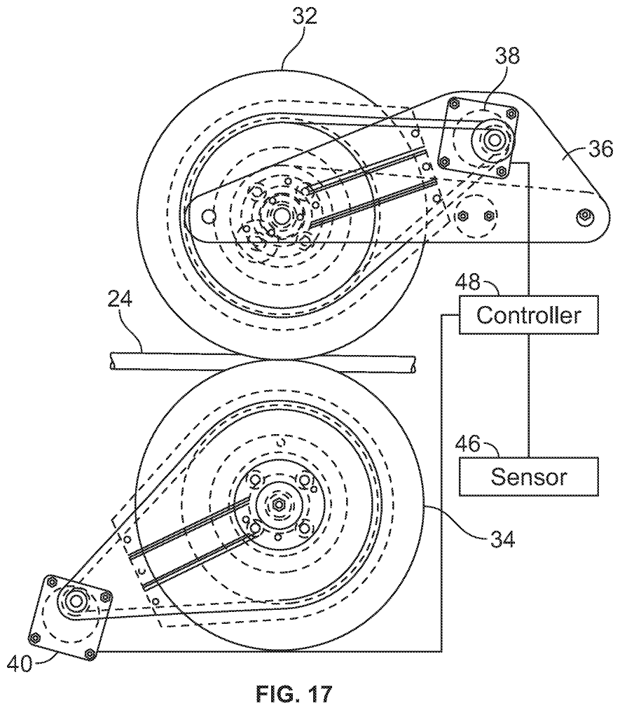

The present disclosure provides a speed adjusting cable assembly 20 for use with a cable feeder 22 and a method of automatically adjusting a speed setting for operation of a cable feeder 22 during a cable feeding operation to account for downstream usage of a cable or cables 24 being pulled through a conduit 26 by a cable puller 28 during a cable installation process. The speed adjusting cable assembly 20 automatically adjusts the speed at which the cable or cables 24 are paid out from the cable feeder 22 by maintaining a preset amount of slack between the cable feeder 22 and the downstream user. A single cable 24 may be pulled from a single reel 30 as shown in FIG. 15, or multiple cables 24 may be pulled from individual reels 30 as shown in FIG. 16. For ease in description, a single cable 24 is described unless otherwise noted. The cable 24 passes through the cable feeder 22, then through the speed adjusting cable assembly 20 and then into the conduit 26.

An example cable feeder 22 that can be used with the speed adjusting cable assembly 20 of the present disclosure is provided in U.S. Pat. No. 6,073,916, which disclosure is herein incorporated by reference. In general, the cable feeder 22 includes upper and lower rotating members 32, 34 mounted on a frame 36. Each rotating member 32, 34 may be a pneumatic tire whose internal air pressure can be selectively varied when pressed against each other and with the cable 24 therebetween. Motors 38, 40 are mounted to the frame 36 and are drivably connected to the respective rotating members 32, 34 to cause rotation of the rotating members 32, 34 to pull the cable 24 therethough for forwarding to the conduit 26. Motors 38, 40 may be any motor that has speed control capabilities. In an embodiment, each motor 38, 40 is a permanent magnet DC motor. In an embodiment, each motor 38, 40 is a variable speed motor.

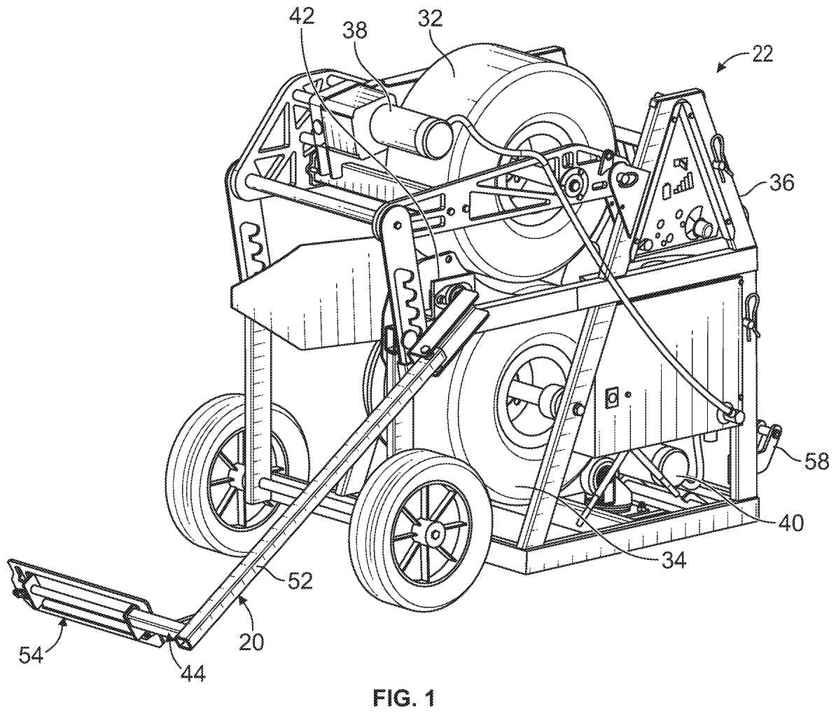

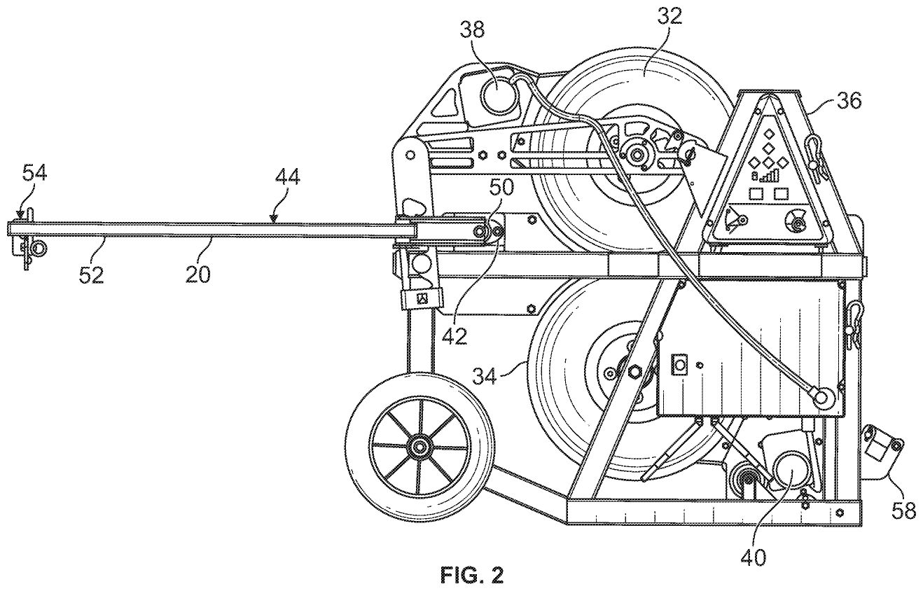

As shown in FIG. 1-3, the speed adjusting cable assembly 20 includes a frame 42, a rotatable boom arm assembly 44 pivotally connected to the frame 42, a sensor 46 in communication with the boom arm assembly 44, and a controller 48 in communication with the sensor 46. The controller 48 is in communication with the cable feeder 22 and controls the speed at which the rotating members 32, 34 operate to feed the cable 24 through the cable feeder 22 based upon information received from the sensor 46.

In an embodiment and as shown, the speed adjusting cable assembly 20 is mounted on the frame 36 of the cable feeder 22 such that the frame 36 of the cable feeder 22 and the frame 42 of the speed adjusting cable assembly 20 are integrally formed. In an embodiment, the speed adjusting cable assembly 20 is provided as an entirely separate component from the cable feeder 22 such that the speed adjusting cable assembly 20 and the cable feeder 22 do not share a frame. If the speed adjusting cable assembly 20 is provided as an entirely separate component from the cable feeder 22, the frame 42 of the speed adjusting cable assembly 20 is fixed in position relative to the frame 36 of the cable feeder 22 during use.

The rotatable boom arm assembly 44 includes a shaft 50 freely rotatably mounted on the frame 42, an L-shaped stiff boom arm 52 having a first end fixedly mounted on the shaft 50 to be rotatable with the shaft 50, and a cable guide 54, 154, 254 at a second end of the boom arm 52. The cable 24 passes through the cable guide 54, 154, 254 such that the cable guide 54, 154, 254 sits on the top surface of the cable 24. The shaft 50 rotates around an axis that is parallel to a horizontal plane β.

The sensor 46 senses the angle of the boom arm 52 relative to the horizontal plane β. In an embodiment, the sensor 46 is a rotary encoder provided on the shaft 50. In an embodiment, the sensor 46 is a potentiometer provided on the shaft 50. Other suitable sensors 46 may be provided for sensing the angle of the boom arm 52 relative to the horizontal plane (3.

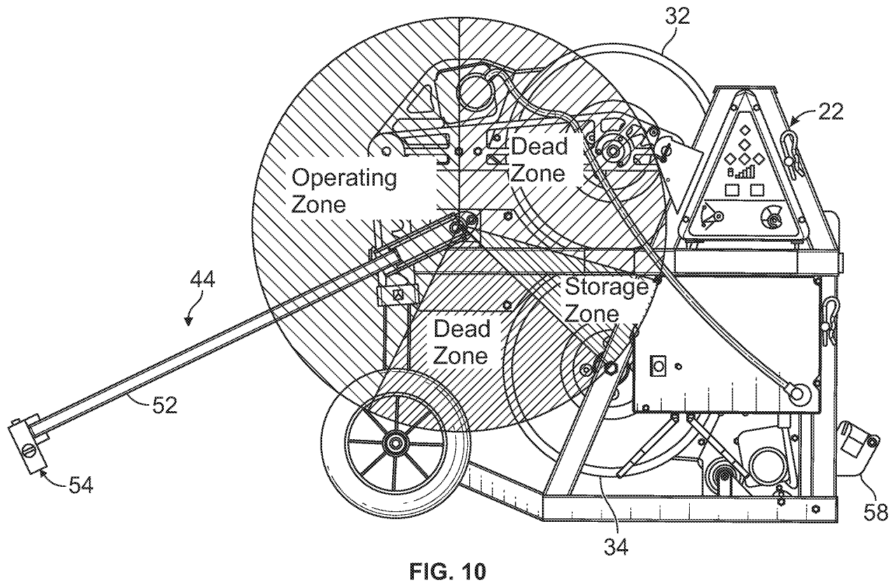

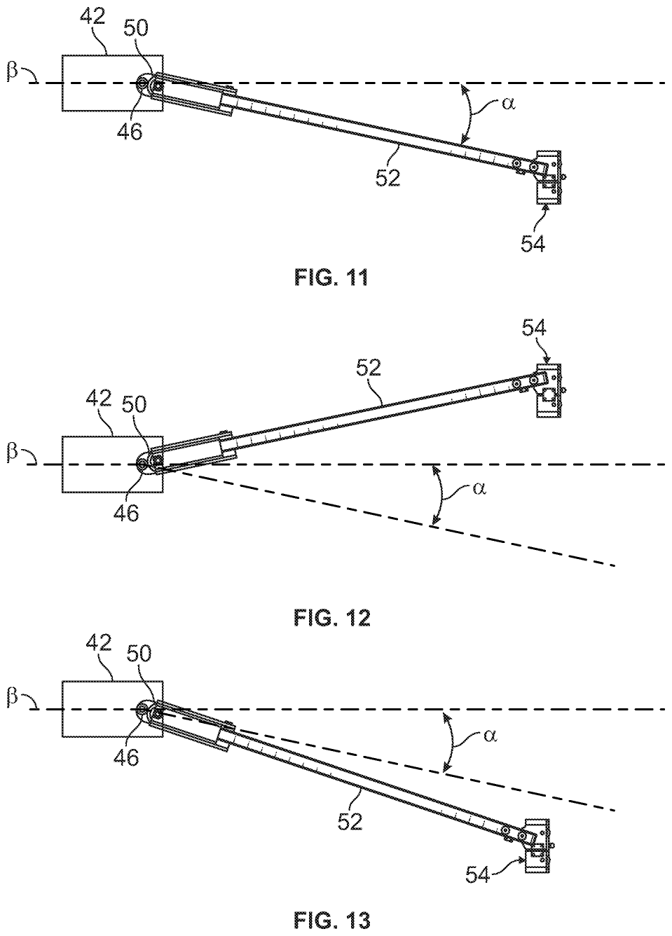

After the cable 24 passes through the cable feeder 22, the speed adjusting cable assembly 20 maintains a desired amount of slack in the cable 24 between the cable feeder 22 and the conduit 26 by adjusting the speed at which the rotating members 32, 34 operate. Since the boom arm 52 is freely rotatable relative to the frame 42 via the shaft 50, and since the cable guide 54, 154, 254 of the boom arm assembly 44 sits on the top surface of the cable 24 and is biased downward by gravity, the boom arm assembly 44 can be used to determine the amount of slack in the cable 24 by measuring the angle of the boom arm 52. To maintain the appropriate amount of slack, the speed at which the rotating members 32, 34 operate is adjusted to increase or decrease the slack in the cable 24, as measured by the angle of the boom arm 52 by using the sensor 46. The speed of the rotating members 32, 34 of the cable feeder 20 is adjusted to keep the boom arm 52 at an optimal angle α relative to the horizontal plane β. The sensor 46 continuously senses information regarding the angular position of the boom arm 52 relative to the horizontal plane β and continuously conveys the information to the controller 48. As an example, as schematically shown in FIGS. 10 and 11, an optimal angle α for the boom arm 52 is at −25 degrees from the horizontal plane β, however, such an optimal angle α is highly dependent on the type of pull being performed. The operating zone may be from −45 degrees from the horizontal plane β to 90 degrees from the horizontal plane β.

If the sensor 46 communicates that the boom arm 52 has rotated to a position vertically above the optimal angle α, indicating that there is not enough slack in the cable 24 as shown for example in FIG. 12, the controller 48 interprets this information and determines that the speed at which the rotating members 32, 34 are being operated should be increased to increase the amount of slack in the cable 24, thereby lowering the boom arm 52 downward closer to the optimal angle. For example, if the optimal angle α for the boom arm 52 is at −25 degrees from the horizontal plane β, any angle sensed by the sensor 46 from −25 degrees to 45 degrees would indicate that there is not enough slack in the cable 24. The controller 48 then controls the operation of the cable feeder 22 to increase the speed of rotation of the rotating members 32, 34 to a level such that slack in the cable 24 is increased, which causes the boom arm 52 to pivot downwardly under gravity.

Conversely, if the sensor 46 communicates that the boom arm 52 has rotated to a position vertically below the optimal angle α, indicating that there is too much slack in the cable 24 as shown for example in FIG. 13, the controller 48 interprets this information and determines that the speed at which the rotating members 32, 34 are being operated should be decreased to decrease the amount of slack in the cable 24, thereby raising the boom arm 52 upward closer to the optimal angle. For example, if the optimal angle α for the boom arm 52 is at −25 degrees from the horizontal plane β, any angle sensed by the sensor 46 from −26 degrees to −45 degrees would indicate that there is too much slack in the cable 24. The controller 48 then controls the operation of the cable feeder 22 to decrease the speed of rotation of the rotating members 32, 34 to a level such that slack in the cable 24 is reduced, which causes the boom arm 52 to pivot upwardly as the slack in the cables is taken up by the cable puller 28.

The desired optimal angle α may be input by a user into the controller 48 based upon the type of cable 24 being pulled and based on the geometry of the feeding setup, such as the location of the cable feeder 22 relative to the conduit 26. Such information may be stored in a memory 56 of the controller 48.

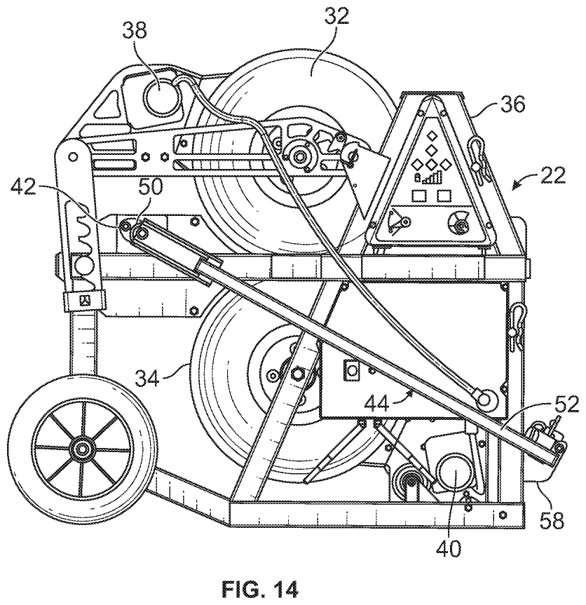

In an embodiment, the boom arm 52 and cable guide 54, 154, 254 can be pivoted to a storage zone or position relative to the frame 42 as shown in FIGS. 10 and 14 which is any position from +45 degrees to +210 degrees. As shown in FIG. 10, dead zones are provided between the storage zone and the normal operating zone. If the boom arm 52 moves into either dead zone, the controller 48 interprets this information and determines that the rotation of the rotating members 32, 34 should be stopped and stops the rotation, or prevents the start of the cable feeder 22. When the boom arm 52 and cable guide 54, 154, 254 are pivoted to the storage zone by the user, the sensor 46 conveys this information to the controller 48 and the controller 48 interprets this data, and the cable feeder 22 can no longer be operated in “automatic” mode. The user should instead run the cable feeder 22 in “manual” mode wherein the rotation of the rotating members 32, 34 are being controlled directly by the user. The frame 42 (or frame 36 if the frames 36, 42 are integrally formed) may have a storage cradle 58 as shown in FIG. 14, extending therefrom upon which the boom arm 52 rests when the boom arm 52 is in a storage position.

The boom arm 52 includes a first arm part 60 which extends from the shaft 50 and a second arm part 62 which is perpendicular to the first arm part 60 such that an L-shaped is formed. The cable guide 54, 154, 254 is attached to the end of the second arm part 62 and can take a variety of forms.

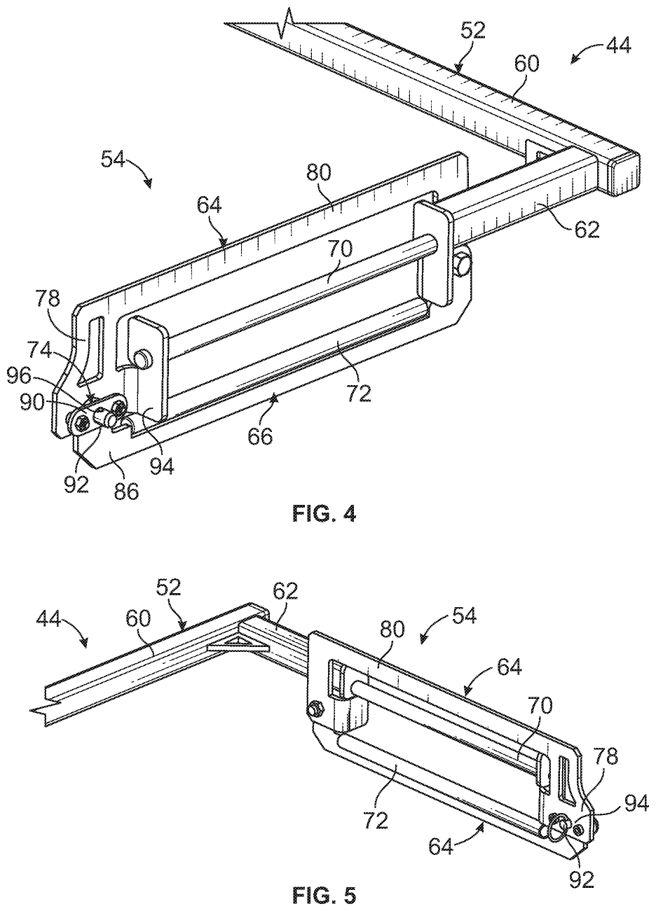

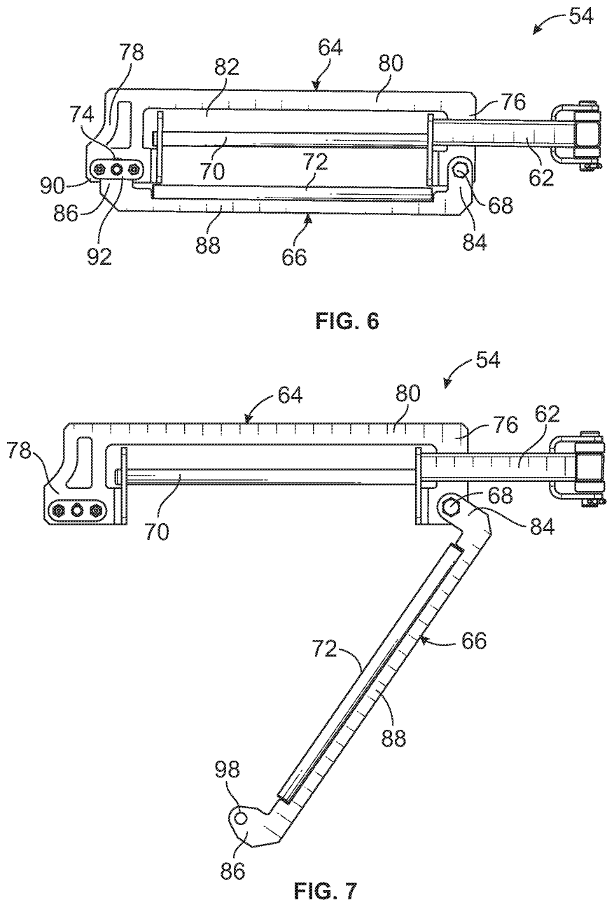

In a first embodiment as shown in FIGS. 4-7, the cable guide 54 includes a housing formed of upper and lower housing portions 64, 66 which are hingedly connected together by a hinge 68, a pair of rollers 70, 72, and a lock assembly 74. When the housing portions 64, 66 are locked together by the lock assembly 74, the housing portions 64, 66 are in the closed position. The lower housing portion 66 can be rotated around the hinge 68 relative to the upper housing portion 64 such that the cable guide 54 is in an open position. The upper housing portion 64 has a pair of end walls 76, 78 which extend perpendicular to a cross-wall 80 extending therebetween such that a U-shape is generally formed. Roller 70 is rotatably attached between the end walls 76, 78, and proximate to the cross-wall 80. The axis of rotation of the roller 70 is parallel to the length of the cross-wall 80. End wall 76 is fixedly attached to the second end of the arm 62. The lower housing portion 66 has a pair of end walls 84, 86 which extend perpendicular to a cross-wall 88 extending therebetween such that a U-shape is generally formed. Roller 72 is rotatably attached between the end walls 84, 86 proximate to the cross-wall 88. The axis of rotation of the roller 72 is parallel to the length of the cross-wall 80. The end walls 76, 84 are connected together by the hinge 68.

The lock assembly 74 releasably secures the upper and lower housing portion 64, 66 together into the closed position in which the rollers 70, 72 vertically align with each other. The lock assembly 74 can take a variety of forms. As shown in the embodiment of FIGS. 4-7, the lock assembly 74 includes a lock wall 90 which extends from the end wall 78 of the upper housing portion 64 and which has a spring-loaded pin 92 which extends through an opening 94 in the end wall 78 and an opening 96 in the lock wall 90. The lock wall 90 has a portion spaced from the end wall 78 such that an upper end portion of the end wall 86 of the lower housing portion 66 which has a receiving opening 98 therethrough can seat therebetween. When the upper and lower housing portions 64, 66 are in the closed position, the spring-loaded pin 92 is inserted into the opening 94 in the end wall 78 of the upper housing portion 64, the receiving opening 98 in the end wall 86 of the lower housing portion 66, and the opening 96 in the lock wall 90 to lock the upper and lower housing portions 64, 66 together.

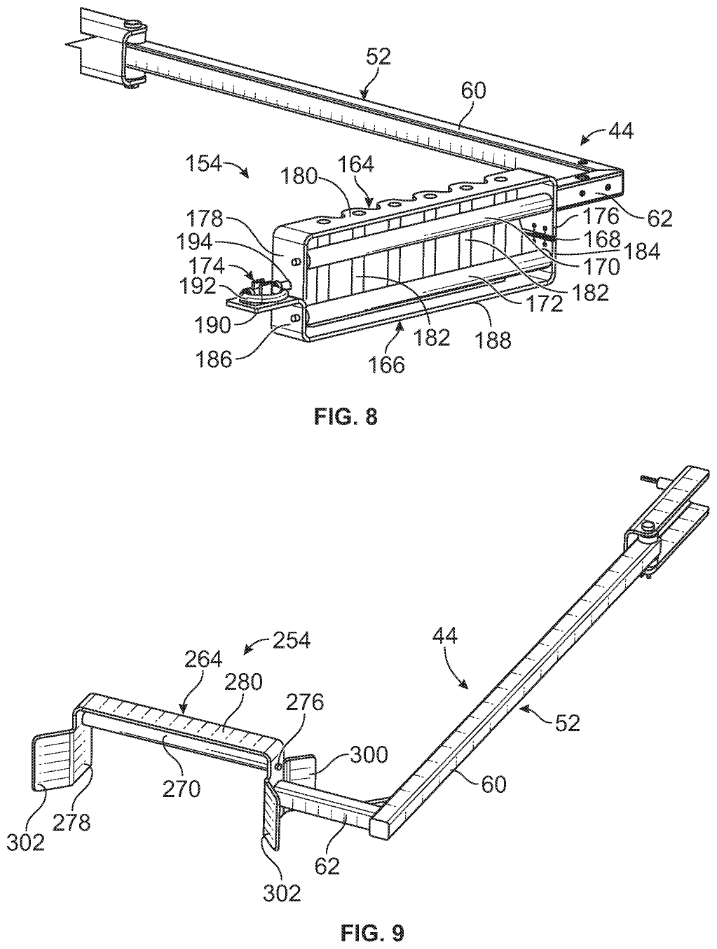

In a second embodiment as shown in FIG. 8, the cable guide 154 includes a housing formed of upper and lower housing portions 164, 166 which are hingedly connected together by a hinge 168, a pair of rollers 170, 172, and a lock assembly 174. When the housing portions 164, 166 are locked together by the lock assembly 174, the housing portions 164, 166 are in the closed position. The lower housing portion 166 can be rotated around the hinge 168 relative to the upper housing portion 164 such that the cable guide 154 is in an open position. The upper housing portion 164 has a pair of end walls 176, 178 which extend perpendicular to a cross-wall 180 extending therebetween such that a U-shape is generally formed. The upper housing portion 164 further includes a plurality of parallel bars 182 which extend perpendicular to the cross-wall 180 and between the end walls 176, 178. Roller 170 is rotatably attached between the end walls 176, 178, and proximate to the cross-wall 180. The axis of rotation of the roller 170 is parallel to the length of the cross-wall 180. End wall 176 is fixedly attached to the second end of the arm 162. The lower housing portion 166 has a pair of end walls 184, 186 which extend perpendicular to a cross-wall 188 extending therebetween such that a U-shape is generally formed. Roller 172 is rotatably attached between the end walls 184, 186 proximate to the cross-wall 188. The axis of rotation of the roller 172 is parallel to the length of the cross-wall 180. The end walls 176, 184 are connected together by the hinge 168.

The lock assembly 174 secures the upper and lower housing portion 164, 166 together into the closed position in which the rollers 170, 172 vertically align with each other. The lock assembly 174 can take a variety of forms. As shown in the embodiment of FIG. 8, the lock assembly 174 includes a lock wall 190 which extends outwardly from the end wall 186 of the lower housing portion 166 and which has a slide bolt 192 mounted thereon. When the upper and lower housing portions 164, 166 are in the closed position, the slide bolt 192 is inserted into a receiving opening 194 in the end wall 178 of the upper housing portion 164 to lock the upper and lower housing portions 164, 166 together. The lock wall 90 may also extend to overlap the end wall 178 when the housing portions 164, 166 are in the closed position and a spring-loaded lock pin extends through openings in the lock wall 90 and the end wall 178 to lock the housing portions 164, 166 together.

While a hinge 68, 168 is provided, as an alternative, the lower housing portion 66, 166 can be complete disengaged from the upper housing portion 64, 164 to allow the passage the cable 24 therethrough, and after the cable 24 is seated in the upper housing portion 64, 164, the user reattaches the lower housing portion 66, 166.

In a third embodiment as shown in FIG. 9, the cable guide 254 includes a housing formed of a housing portion 264 having pair of end walls 276, 278 which extend perpendicular to a cross-wall 280 extending therebetween such that a U-shape is generally formed, and a roller 270 rotatably attached between the end walls 276, 278 proximate to the cross-wall 280. The axis of rotation of the roller 270 is parallel to the length of the cross-wall 280. End wall 276 is fixedly attached to the second end of the arm 62. Each end wall 276, 278 has an angled lead-in wall 300 which faces the cable feeder 22 when in an in-use position, and an angled lead-out wall 302 which faces away from the cable feeder 22. The walls 300 angle outwardly from each other; the walls 302 angle outwardly from each other. The walls 300 may be angled at a 45-degree angle relative to the respective end wall 276, 278, and the walls 302 may be angled at a 45-degree angle relative to the respective end wall 276, 278.

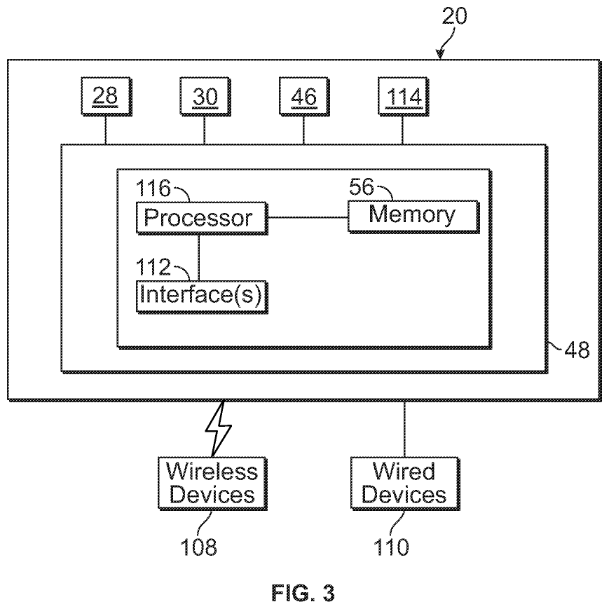

The controller 48 may be at least partially mounted on the frame 36 or 42, and/or may be at least partially located in a remote location to the frame 36 or 42. For example, the controller 48 may be mounted to the frame 36 or 42, and/or may be disposed remotely from the frame 36 or 42, but that may be communicatively coupled to the sensor 46 and to the motors 38, 40 of the cable feeder 22, such as through a wireless and/or wired communication 108, 110, see FIG. 3. The controller 48 may also be in wireless and/or wired communication with the cable puller 28.

As shown in FIG. 3, in some example embodiments, the controller 48 may be configured to provide a user interface 112 to display and/or enter data used to operate the cable feeder 22. The user interface 112 may include a display with a touchscreen for a user to interact with control buttons and/or a keypad of the user interface 112, and/or to view and enter cable type information and other data into the cable feeder 22. Other types of possible user interfaces 112 include but are not limited to a physical keyboard, mouse, trackball, switches, physical buttons, etc. A foot pedal or hand pendant 114 or the like, which is in communication with the controller 48, may be provided to turn the cable feeder 22 on or off. The controller 48 can also include a non-transitory memory 56 for storing data received from the sensor 46 and a processor 116 configured to process information received from the sensor 46. In some example embodiments, the memory 56 may include non-transitory memory. The memory 56 can store inputted cable type information and other data, and also store instructions (e.g., compiled executable program instructions, uncompiled program code, some combination thereof, or the like), which when performed (e.g., executed, translated, interpreted, and/or the like) by the processor 116, causes the processor 116 to perform the processes described herein. In this regard, the processor 116 is configured to control operation of the motors 38, 40 based at least in part on data received from the sensor 46, code stored in memory 56, and/or based on a hardware configuration of the processor 116.

In an embodiment, the controller 48 is in communication with the motors 38, 40 and is configured to control the speed of the motors 38, 40 so that the rotating members 32, 34 are rotated at a speed which maintains the optimal angle α. In some embodiments, the motors 38, 40 include interfaces, such as CAN bus interfaces configured to receive control signals from the controller 48. Other types of communication interfaces can be used to send control signals to the motors 38, 40. Although it is preferred that both rotating members 32, 34 are directly driven by separate motors 38, 40, it is also possible to provide that one of the rotating members 32, 34 is an idler (i.e. is passive or not driven), and instead rotates as a result of movement of the cable 24 which is caused by the rotation of the other rotating member 34, 32. In another embodiment, the motors 38, 40 or motor are driven at a constant speed and the controller 48 controls a clutch (not shown) which retards the speed of rotation of the rotating members 32, 34 to maintain the optimal angle α.

Operation of the speed adjusting cable assembly 20 is now be described. Initially, the cable feeder 22 is positioned in a stationary position in front of the reel(s) 30, and the speed adjusting cable assembly 20 is positioned in a stationary position in front of the cable feeder 22. Once positioned, the boom arm 52 is pivoted into a position such that the boom arm 52 is above the cable 24 and will not interfere with the cable 24 when the cable 24 is being loaded into the cable guide 54, 154, 254. The boom arm 52 may be pivoted to the storage position for this use. If multiple cables 24 are being fed, the ends of the cables 24 are coupled together in a known manner and are then fed between the rotating members 32, 34.

If the first embodiment of the boom arm 52 with the cable guide 54 of FIGS. 4-7 is used, the lock assembly 74 of the cable guide 54 is unlocked and the lower housing portion 66 is pivoted relative to the upper housing portion 64 to the open position prior to engagement of the boom arm 52 with the cable 24. The boom arm 52 is then rotated around the shaft 50 to engage the cable guide 54 with the cable(s) 24 and the cable(s) 24 is(are) inserted between the end walls 76, 78. The cable guide 54 is moved to the closed position and locked using the lock assembly 74 to attach the cable(s) 24 to the cable guide 54. The cable(s) 24 is(are) trapped between the end walls 84, 86 when the cable guide 54 is moved to the closed and locked positions. The cable(s) 24 passes between the rollers 70, 72.

If the second embodiment of the boom arm 52 with the cable guide 154 of FIG. 8 is used, the lock assembly 174 of the cable guide 154 is unlocked and the lower housing portion 166 is pivoted relative to the upper housing portion 164 to the open position prior to engagement of the boom arm 52 with the cable(s) 24. The boom arm 52 is then rotated around the shaft 50 to engage the cable guide 154 with the cable(s) 24 and the cable(s) 24 is(are) inserted into respective channels between the bars 182. The cable guide 154 is then moved to the closed position and locked using the lock assembly 174 to attach the cable(s) 24 to the cable guide 154. The cable(s) 24 passes between the rollers 170, 172 after passing between the bars 182.

If the third embodiment of the boom arm 52 with the cable guide 254 of FIG. 9 is used, the boom arm 52 is rotated around the shaft 50 to engage the cable guide 254 with the cable(s) 24. The cable(s) 24 is(are) inserted between the end walls 276, 278 and the roller 290 rests on top of the cable(s) 24. The angled lead-in and lead-out walls 300, 302 assist in directing the cable(s) 24 through the cable guide 254.

Once the cable 24 is fed to the cable feeder 22, the motors 38, 40 are actuated, thereby causing rotation of the rotating members 32, 34 and pulling the cable 24 off its reel 30 and feeding the cable 24 forward to the conduit 26. During the feeding operation, the rotating members 32, 34 move the cable 24 as a result of frictional engagement between the rotating members 32, 34 and the cable 24. The speed adjusting cable assembly 20 is then used to regulate the speed of rotation of the rotating member 32, 34 as described herein in order to maintain the desired amount of slack in the cable 24.

Also, the following examples are provided, which are numbered for easier reference.

1. A speed adjusting cable assembly configured for use with a cable feeder having at least one motor-driven roller configured to pay out cable, the speed adjusting cable assembly comprising: a frame; a boom arm pivotally connected to the frame by a shaft, the boom arm having a cable guide thereon which is configured to allow at least one cable to pass therethrough; a sensor in communication with the shaft and configured to measure a rotational position of the boom arm relative to a plane; and a controller in communication with the sensor, the controller configured to control a speed at which the at least one motor-driven roller rotates to feed the cable through the cable feeder based upon information received from the sensor.
2. The speed adjusting cable assembly of example 1, wherein the cable guide includes a housing which is configured to sit on a top surface of the cable.
3. The speed adjusting cable assembly of example 2, further comprising a roller rotatably attached to the housing.
4. The speed adjusting cable assembly of example 2, wherein the housing has a pair of angled lead-in walls through which the cable passes.
5. The speed adjusting cable assembly of example 2, wherein the housing has a plurality of bars forming channels through which the cable can pass.
6. The speed adjusting cable assembly of example 1, wherein the boom arm includes a cable guide having an upper housing portion and a lower housing portion attached to the upper housing portion, wherein the lower housing portion can be at least partially disengaged from the upper housing portion, and further comprising a releasable lock attached to the cable guide and configured to be unlocked to allow the lower housing portion to rotate relative to the upper housing portion.
7. The speed adjusting cable assembly of example 6, wherein the upper housing portion and the lower housing portion are pivotally attached to each other by a hinge.
8. The speed adjusting cable assembly of example 6, further comprising an upper roller rotatably attached to the upper housing portion, and a lower roller rotatably attached to the lower housing portion, wherein the cable passes between the rollers.
9. The speed adjusting cable assembly of example 8, wherein the housing has a plurality of bars forming channels through which the cable can pass.
10. The speed adjusting cable assembly of example 1, wherein the sensor is one of a rotary encoder and a potentiometer provided on the shaft.
11. The speed adjusting cable assembly of example 1, further comprising a storage cradle on the frame, wherein the boom arm is configured to be moved into the storage cradle for storage.
12. An assembly comprising: a cable feeder comprising a frame, a roller mounted on the frame and a motor operatively coupled to the roller to rotate the roller so that cable is paid out; and a speed adjusting cable assembly comprising: a frame, a boom arm pivotally connected to the frame of the speed adjusting cable assembly by a shaft, the boom arm having a housing which is configured to sit on a top surface of the cable, and a roller attached to the housing, a sensor in communication with the shaft and configured to measure a rotational position of the boom arm, and a controller in communication with the sensor, the controller configured to control a speed at which the roller rotates to feed the cable through the cable feeder based upon information received from the sensor.
13. The assembly of example 12, wherein the housing of the speed adjusting cable assembly includes an upper housing portion and a lower housing portion attached to the upper housing portion, wherein the lower housing portion can be at least partially disengaged from the upper housing portion, and a releasable lock attached to the housing and configured to be unlocked to allow the lower housing portion to rotate relative to the upper housing portion.
14. The assembly of example 13, wherein the upper housing portion and the lower housing portion are pivotally attached to each other by a hinge.
15. The assembly of example 13, wherein the roller is an upper roller rotatably attached to the upper housing portion, and further comprising a lower roller rotatably attached to the lower housing portion, wherein the cable passes between the upper and lower rollers.
16. The assembly of example 12, wherein the sensor is one of a rotary encoder and a potentiometer provided on the shaft.
17. The assembly of example 12, wherein the cable feeder comprises a pair of motor-driven rollers mounted on the frame of the cable feeder, wherein the cable passes between the motor-driven rollers of the cable feeder, wherein the controller controls rotation of both motor-driven rollers.
18. The assembly of example 12, wherein the frame of the cable feeder and the frame of the speed adjusting cable assembly are integrally formed.
19. The assembly of example 12, further comprising a cable puller.
20. A method of paying out cable comprising: feeding a cable between rollers of a cable feeder, wherein at least one of the rollers is driven by a motor; feeding a cable through a cable guide of a speed adjusting cable assembly with a housing of the speed adjusting cable assembly sitting on a top surface of the cable; sensing a rotational position of the cable guide relative to a plane; and changing a speed at which the roller rotates. roller. Many modifications and other embodiments of the disclosure set forth herein will come to mind to one skilled in the art to which these disclosed embodiments pertain having the benefit of the teachings presented in the foregoing descriptions and the associated drawings.

Therefore, it is to be understood that the disclosure is not to be limited to the specific embodiments disclosed herein and that modifications and other embodiments are intended to be included within the scope of the disclosure. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure. In this regard, for example, different combinations of elements and/or functions than those explicitly described above are also contemplated within the scope of the disclosure. Although specific terms are employed herein, they are used in a generic and descriptive sense only and not for purposes of limitation.

While particular embodiments are illustrated in and described with respect to the drawings, it is envisioned that those skilled in the art may devise various modifications without departing from the spirit and scope of the appended claims. It will therefore be appreciated that the scope of the disclosure and the appended claims is not limited to the specific embodiments illustrated in and discussed with respect to the drawings and that modifications and other embodiments are intended to be included within the scope of the disclosure and appended drawings. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure and the appended claims.

What is claimed is:

1. A speed adjusting cable assembly configured for use with a cable feeder having at least one motor-driven roller configured to pay out cable, the speed adjusting cable assembly comprising:
a frame;
a boom arm pivotally connected to the frame by a shaft, the boom arm having a cable guide thereon which is configured to allow at least one cable to pass therethrough;
a sensor in communication with the shaft and configured to measure a rotational position of the boom arm relative to a plane; and
a controller in communication with the sensor, the controller configured to control a speed at which the at least one motor-driven roller rotates to feed the cable through the cable feeder based upon information received from the sensor.

2. The speed adjusting cable assembly of claim 1, wherein the cable guide includes a housing which is configured to sit on a top surface of the cable.

3. The speed adjusting cable assembly of claim 2, further comprising a roller rotatably attached to the housing.

4. The speed adjusting cable assembly of claim 2, wherein the housing has a pair of angled lead-in walls through which the cable passes.

5. The speed adjusting cable assembly of claim 2, wherein the housing has a plurality of bars forming channels through which the cable can pass.

6. The speed adjusting cable assembly of claim 1, wherein the boom arm includes a cable guide having an upper housing portion and a lower housing portion attached to the upper housing portion, wherein the lower housing portion can be at least partially disengaged from the upper housing portion, and further comprising a releasable lock attached to the cable guide and configured to be unlocked to allow the lower housing portion to rotate relative to the upper housing portion.

7. The speed adjusting cable assembly of claim 6, wherein the upper housing portion and the lower housing portion are pivotally attached to each other by a hinge.

8. The speed adjusting cable assembly of claim 6, further comprising an upper roller rotatably attached to the upper housing portion, and a lower roller rotatably attached to the lower housing portion, wherein the cable passes between the rollers.

9. The speed adjusting cable assembly of claim 8, wherein the housing has a plurality of bars forming channels through which the cable can pass.

10. The speed adjusting cable assembly of claim 1, wherein the sensor is one of a rotary encoder and a potentiometer provided on the shaft.

11. The speed adjusting cable assembly of claim 1, further comprising a storage cradle on the frame, wherein the boom arm is configured to be moved into the storage cradle for storage.

12. An assembly comprising:
a cable feeder comprising a frame, a roller mounted on the frame and a motor operatively coupled to the roller to rotate the roller so that cable is paid out; and
a speed adjusting cable assembly comprising: a frame, a boom arm pivotally connected to the frame of the speed adjusting cable assembly by a shaft, the boom arm having a housing which is configured to sit on a top surface of the cable, and a roller attached to the housing, a sensor in communication with the shaft and configured to measure a rotational position of the boom arm relative to a plane, and a controller in communication with the sensor, the controller configured to control a speed at which the roller rotates to feed the cable through the cable feeder based upon information received from the sensor.

13. The assembly of claim 12, wherein the housing of the speed adjusting cable assembly includes an upper housing portion and a lower housing portion attached to the upper housing portion, wherein the lower housing portion can be at least partially disengaged from the upper housing portion, and a releasable lock attached to the housing and configured to be unlocked to allow the lower housing portion to rotate relative to the upper housing portion.

14. The assembly of claim 13, wherein the upper housing portion and the lower housing portion are pivotally attached to each other by a hinge.

15. The assembly of claim 13, wherein the roller is an upper roller rotatably attached to the upper housing portion, and further comprising a lower roller rotatably attached to the lower housing portion, wherein the cable passes between the upper and lower rollers.

16. The assembly of claim 12, wherein the sensor is one of a rotary encoder and a potentiometer provided on the shaft.

17. The assembly of claim 12, wherein the cable feeder comprises a pair of motor-driven rollers mounted on the frame of the cable feeder, wherein the cable passes between the motor-driven rollers of the cable feeder, wherein the controller controls rotation of both motor-driven rollers.

18. The assembly of claim 12, wherein the frame of the cable feeder and the frame of the speed adjusting cable assembly are integrally formed.

19. The assembly of claim 12, further comprising a cable puller.

20. A method of paying out cable comprising:
feeding a cable between rollers of a cable feeder, wherein at least one of the rollers is driven by a motor;
feeding a cable through a cable guide of a speed adjusting cable assembly with a housing of the speed adjusting cable assembly sitting on a top surface of the cable;
sensing a rotational position of the cable guide relative to a plane; and
changing a speed at which the roller rotates.
